(19) United States
(12) Patent Application Publication
(10) Pub. No.: US 2026/0278607 A1
(43) Pub. Date: Sep. 17, 2026

(54) DYNAMIC ENCRYPTION FOR SECURE PERSONAL IDENTIFICATION NUMBER ENTRY

(71) Applicant: Visa International Service Association, San Francisco, CA (US)

(72) Inventors: Yuexi CHEN, Foster City, CA (US); Esha DUTTA, Leander, TX (US); Geraldine MITCHLEY, San Francisco, CA (US); Ian JAVKIN, San Francisco, CA (US)

(73) Assignee: Visa International Service Association, San Francisco, CA (US)

(21) Appl. No.: 19/472,169

(22) PCT Filed: Apr. 21, 2023
(86) PCT No.: PCT/US2023/019353

§ 371 Date: Oct. 3, 2025

(51) Int. Cl. G06Q 20/40; G06Q 20/38

(52) U.S. Cl. CPC G06Q 20/4012; G06Q 20/3829; G06Q 20/40145; G06Q 20/4015

(57) ABSTRACT

The present disclosure provides various devices, systems, and methods for securely providing a personal identification number (PIN), for securely accepting a PIN, and for authenticating a transaction based on a securely provided PIN. In one aspect, a method for securely providing a user PIN can include receiving, by a portable electronic device, a device key provisioned by a server. The device key can be associated with a payment card. The method can further include receiving, by the portable electronic device, a request for an encrypted PIN to authenticate a transaction initiated using the payment card and generating, by a PIN encryption application executed by the portable electronic device, the encrypted PIN based on the user PIN and the device key. The encrypted PIN can be provided to an access device. The access device can be configured to communicate the encrypted PIN to the server.

### TECHNICAL FIELD

At least some aspects of the present disclosure relate to improving security for transactions initiated using a payment card (e.g., a credit card, a debit card), and more particularly, to improving security related to providing a personal identification number (PIN) for a transition initiated using a payment card.

### BACKGROUND

Some payment card transactions, such as purchases and automated teller machine (ATM) withdrawals, can require that a consumer provide a personal identification number (PIN) for consumer authentication. The PIN is often static and often includes a string of four to six digits. However, a static PIN can be susceptible to many types of fraud-related attacks. For example, some consumers may choose weak PINs that are easy for fraudsters to guess (e.g. 1234). As another example, even where consumers chose strong PINs that are not easy to guess, fraudsters may steal the PINs using various other malicious strategies (e.g., spoofing using camera, spoofing using skimming device, demanding a PIN using a fake website, phishing via a telephone call or Email demanding a PIN, etc.).

Furthermore, various software applications and hardware accessories have been developed to transform off-the-shelf portable electronic devices, such as smartphones and tablets, into point-of-sale devices. For example, a point-of-sale application may be installed onto a merchant's smartphone to enable the merchant's smartphone to interact with a consumer's payment card to accept a contactless payment (e.g., sometimes called a Tap-to-Phone transaction (TTP) or a Tap to Pay on Phone transaction). In cases where the merchant is using a portable electronic device as a point-of-sale device, the consumer may be asked to enter the PIN on a touch screen of the merchant's portable electronic device. However, entering the PIN on a touch screen of the merchant's portable electronic device may expose the consumer to potential fraud. For example, a fraudster posing as a merchant may ask the consumer to enter the PIN on a portable electronic device that is operating a malicious application intended to look like a legitimate point-of-sale application. The malicious application may be designed to record the consumer's PIN, thereby enabling the fraudster to subsequently carry out fraudulent transactions using the PIN.

Accordingly, there is a need for devices, systems, and methods for securely providing a PIN, securely accepting a PIN, and authenticating a transaction based on a securely provided PIN. The present disclosure provides various solutions that employ a dynamically encrypted PIN.

### SUMMARY

In one aspect, the present disclosure provides a method for securely providing a user personal identification number (PIN). The method can include receiving, by a portable electronic device, a device key provisioned by a server. The device key can be associated with a payment card. The method can further include receiving, by the portable electronic device, a request for an encrypted PIN to authenticate a transaction initiated using the payment card and generating, by a PIN encryption application executed by the portable electronic device, the encrypted PIN based on the user PIN and the device key. The encrypted PIN can be provided to an access device. The access device can be configured to communicate the encrypted PIN to the server.

In another aspect, the present disclosure provides a method for authenticating a transaction. The transaction can be initiated using a payment card and an access device. The transaction can require authentication based on a user personal identification number (PIN). An encrypted PIN generated based on the user PIN can be provided to the access device to authenticate the transaction. The method can include receiving, by a server, a transaction authentication request comprising the encrypted PIN from the access device. The transaction authentication request can be associated with a personal account number (PAN). The method can further include determining, by the server, the PAN is associated with a PIN encryption service, mapping, by the server, the PAN to a token, and retrieving, by the server, a device key based on the token. The server can determine the user PIN by decrypting the encrypted PIN based on the device key.

In yet another aspect, the present disclosure provides a portable electronic device. The portable electronic device can include a display screen, a processor, and a memory. The memory can include instructions executable by the processor to receive a request to enroll a payment card to a personal identification number (PIN) encryption service and receive a device key provisioned by a server. The device key can be associated with the payment card. The memory can further include instructions executable by the processor to cause the display screen to display a first user interface for receiving a user PIN. The memory can further include instructions executable by the processor to generate an encrypted PIN based on the user PIN and the device key. The encrypted PIN can be for authenticating a transaction initiated using the payment card and an access device. The memory can further include instructions executable by the processor to cause the display screen to display a second user interface comprising the encrypted PIN. The access device can be configured receive the encrypted PIN and communicate the encrypted PIN to the server.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, together with the detailed description below, are incorporated in and form part of the specification, and serve to further illustrate aspects of concepts that include the claimed disclosure and explain various principles and advantages of those aspects.

The apparatuses and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates a payment network environment, according to at least one aspect of the present disclosure.

FIG. 2 shows a swimlane diagram illustrating a method for configuring and operating a personal identification number (PIN) encryption application, according to at least one aspect of the present disclosure.

FIG. 3 shows a swimlane diagram illustrating a method for enrolling a payment card to a PIN encryption application, according to at least one aspect of the present disclosure.

FIGS. 4A-4B show a swimlane diagram illustrating a method for conducting a transaction based on an encrypted PIN, according to at least one aspect of the present disclosure.

FIG. 5A-5B illustrate a portable electronic device displaying user interface screens generated by a PIN encryption application, according to at least one aspect of the present disclosure.

FIG. 6 is a flow diagram of a method for generating an encrypted PIN based on a user PIN, according to at least one aspect of the present disclosure.

FIG. 7 is a flow diagram of a method for decrypting an encrypted PIN to determine a user PIN, according to at least one aspect of the present disclosure.

FIG. 8 is a flow diagram of a method for securely providing a PIN, according to at least one aspect of the present disclosure.

FIG. 9 is a flow diagram of a method for authenticating a transaction based on a securely provided PIN, according to at least one aspect of the present disclosure.

FIG. 10 is a block diagram of a portable electronic device, according to at least one aspect of the present disclosure.

FIG. 11 is a block diagram of a computer apparatus with data processing subsystems or components, according to at least one aspect of the present disclosure.

FIG. 12 is a diagrammatic representation of an example system that includes a host machine, according to at least one aspect of the present disclosure.

Corresponding reference characters indicate corresponding parts throughout the several views. The exemplifications set out herein illustrate various aspects of the present disclosure, in one form, and such exemplifications are not to be construed as limiting the scope of the disclosure in any manner.

### DESCRIPTION

Before explaining various forms of the vicinity use card, it should be noted that the illustrative forms disclosed herein are not limited in application or use to the details of construction and arrangement of components illustrated in the accompanying drawings and description. The illustrative forms may be implemented or incorporated in other forms, variations and modifications, and may be practiced or carried out in various ways. Further, unless otherwise indicated, the terms and expressions utilized herein have been chosen for the purpose of describing the illustrative forms for the convenience of the reader and are not for the purpose of limitation thereof. Also in the following description, it is to be understood that terms such as “forward,” “rearward,” “left,” “right,” “above,” “below,” “upwardly,” “downwardly,” and the like are words of convenience and are not to be construed as limiting terms.

As described above, some payment card transactions can require that a consumer provide a static personal identification number (PIN) for consumer authentication. However, static PINs can be susceptible to many types of fraud-related attacks. For example, some consumers may choose weak PINs that are easy for fraudsters to guess (e.g. 1234). As another example, fraudsters may steal PINs using various malicious strategies (e.g., spoofing using camera, spoofing using skimming device, demanding a PIN using a fake website, demanding a PIN using a fake smartphone application, phishing via a telephone call or Email demanding a PIN, etc.). Accordingly, there is a need for devices, systems, and methods for securely providing a PIN, securely accepting a PIN, and authenticating a transaction based on a securely provided PIN.

The present disclosure provides various devices, systems, and methods for securely providing a PIN, for securely accepting a PIN, and for authenticating a transaction based on a securely provided PIN. The devices, systems, and methods can employ a dynamically encrypted PIN generated by a portable electronic device. For example, a method for securely providing a PIN can include receiving, by a portable electronic device, a device key provisioned by a server. The device key can be associated with a payment card. The payment card may be used to initiate a transaction with an access device. The transaction may require a PIN for authentication. Thus, the method for securely providing the PIN can further include receiving, by the portable electronic device, a request for an encrypted PIN to authenticate the transaction. A PIN encryption application executed by the portable electronic device can generate a dynamically encrypted PIN based on a user PIN (e.g., a static PIN) and the device key. The dynamically encrypted PIN can be provided to the access device. The access device can be configured to communicate the dynamically encrypted PIN to the server for decryption.

The devices, systems, and methods provided herein can provide numerous benefits. For example, although the encrypted PIN is provided to the access device, and therefore may be stolen by a fraudster using various malicious methods (e.g., spoofing, relay attacks, malicious applications intended to look like legitimate point-of-sale application), the encrypted PIN is dynamically encrypted and therefore may be valid for only a limited number of transactions (e.g., one transaction). Moreover, the fraudster is not able to decrypt the encrypted PIN to determine the underlying user PIN. Accordingly, a fraudster who has stolen the encrypted PIN may not subsequently carry out fraudulent transactions using the encrypted PIN. Thus, the devices, systems and methods provided herein can retain the benefits associated with traditional PIN-protected transactions while avoiding issues related to the fraudulent use of stolen PINs.

As another example, the devices, systems, and methods provided herein can be employed using existing payment infrastructure, hardware, software, and/or communication protocols. For example, the encrypted PIN can be in the same format as a static PIN and can therefore be transmitted across a payment network using existing communication protocols (e.g., the encrypted PIN can be compatible with the International Organization for Standardization (ISO) PIN block format). Thus, the devices, systems, and methods provided herein can be implemented without modifying existing messaging standards.

As yet another example, many payment card users also frequently carry a portable electronic device while making transactions. Accordingly, the users can conveniently use their existing portable electronic device to generate the encrypted PIN.

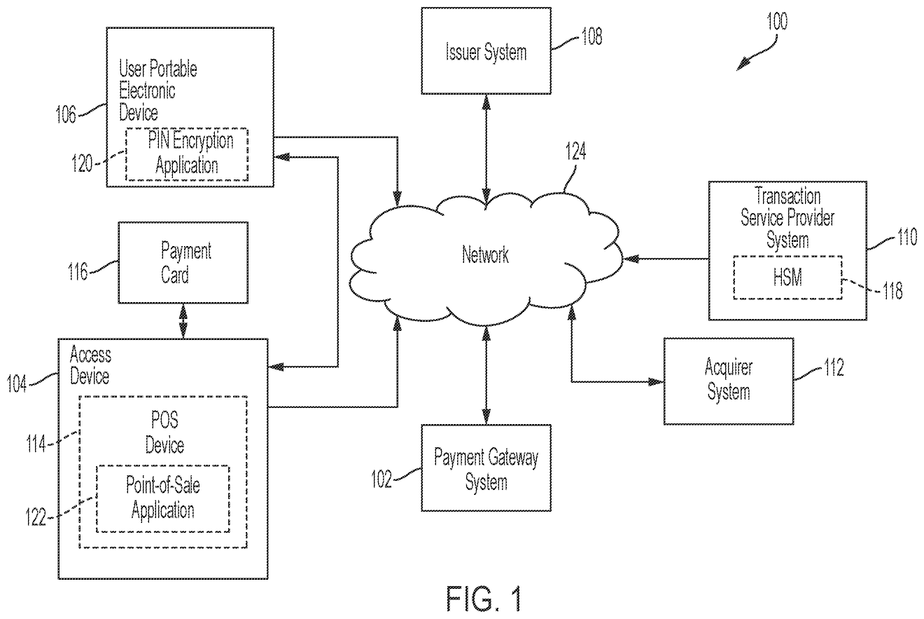

FIG. 1 is a diagram of a payment network environment 100 in which a transaction may be conducted based on an encrypted PIN, according to at least one aspect of the present disclosure. As shown in FIG. 1, the payment network environment 100 can include a payment gateway system 102, an access device 104, a user portable electronic device 106, an issuer system 108, a transaction service provider system 110, an acquirer system 112, a network 124, and a payment card 116. The payment gateway system 102, the access device 104, the user portable electronic device 106, the issuer system 108, the transaction service provider system 110, and/or the acquirer system 112 may interconnect (e.g., establish a connection to communicate) via wired connections, wireless connections, or a combination of wired and wireless connections.

A “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

A “system” may refer to one or more computing devices or combinations of computing devices (e.g., processors, servers, client devices, software applications, components of such, and/or the like).

Referring again to FIG. 1, the access device 104 may include one or more devices capable of receiving information from and/or transmitting information to the payment gateway system 102, the user portable electronic device 106, the issuer system 108, the transaction service provider system 110, and/or the acquirer system 112 via the network 124.

An “access device” may be any suitable device that provides access to a remote system. An access device may also be used for communicating with a merchant computer, a transaction processing computer, an authentication computer, or any other suitable system. An access device may generally be located in any suitable location, such as at the location of a merchant. An access device may be in any suitable form. Some examples of access devices include POS or point-of-sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, and the like. An access device may use any suitable contact or contactless mode of operation to send or receive data from, or associated with, a payment card and/or a user portable electronic device. For example, an access device may include a reader, a processor, and a computer-readable medium. A reader can include a radio frequency (RF) antenna, an optical scanners, a bar code reader, and/or a magnetic stripe readers to interact with a payment card and/or portable electronic device.

Referring again to FIG. 1, in some aspects, the access device 104 can comprise a point-of-sale (POS) device 114. The POS device 114 may include one or more than one device, such a computer, a computer system, a portable electronic device, and/or a peripheral device capable of being used by a merchant to conduct a payment transaction with a user, for example, using the user portable electronic device 106 and/or the payment card 116. In some aspects, the POS device 114 may be a component of a merchant system associated with a merchant. In some aspects, the POS device 114 can be configured to receive information from the user portable electronic device 106 and/or the payment card 116 via a communication connection (e.g., a near field communication (NFC) connection, a radio-frequency identification (RFID) communication connection, a Bluetooth® communication connection, and/or the like) and/or transmit information to the user portable electronic device 106 and/or the payment card 116 via the communication connection.

A “merchant” may refer to one or more individuals or entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein “merchant system” may refer to one or more computer systems operated by or on behalf of a merchant, such as a server computer executing one or more software applications.

A “user” may include an individual. In some embodiments or aspects, a user may be associated with one or more personal accounts, payment cards, and/or portable electronic devices. The user may also be referred to as a cardholder, account holder, or consumer.

A “payment card” or “payment device” may refer to any device that may be used to conduct a transaction, such as a financial transaction. For example, a payment card may be used to provide payment information to a merchant. A payment card can include a substrate such as a paper, metal, or plastic card, and information that is printed, embossed, encoded, and/or otherwise included at or near a surface of the payment card. A payment card can be hand-held and compact so that it can fit into a consumer's wallet and/or pocket (e.g., pocket-sized). A payment card can be a smart card, a debit device (e.g., a debit card), a credit device (e.g., a credit card), a stored value device (e.g., a stored value card or “prepaid” card), a magnetic stripe or chip card. A payment card may operate in a contact and/or contactless mode. For example, a payment card may be an electronic payment device, such as a smart card, a chip card, an integrated circuit card, and/or a near field communications (NFC) card, among others. An electronic payment device may include an embedded integrated circuit and the embedded integrated circuit may include a data storage medium (e.g., volatile and/or non-volatile memory) to store information associated with the electronic payment device, such as an account identifier and/or a name of an account holder. A payment card may interface with an access device such as a POS device to initiate the transaction.

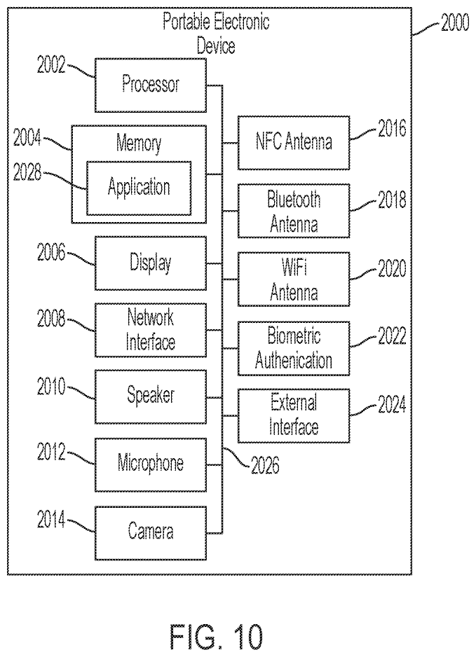

Referring again to FIG. 1, as noted above, the POS device 114 can include a portable electronic device. For example, a merchant portable electronic device that is operating a point-of-sale application 122 can be a POS device 114. In at least one aspect, a POS device 114 operating the point-of-sale application 122 can be similar to the portable electronic device 2000 described herein with respect to FIG. 10. The POS device 114 can include a processor and a memory. The memory can store the point-of-sale application 122 such that it is executable by the processor to enable a portable electronic device to function as the POS device 114.

A “portable electronic device” may refer to any electronic device that is portable and operated by user and/or a merchant. Examples of portable electronic devices include smartphones and other mobile phones (e.g., cellular phones), tablet computers, laptop computers, netbooks, personal music players, e-readers, hand-held specialized readers, mobile Wi-Fi devices, handheld gaming systems, navigation systems, storage devices, portable media players, wearable devices (e.g., fitness bands, smart watches, headphones, earbuds), various electronic devices included in automobiles, and any other electronic device that a user may transport, carry, and/or wear. Other portable electronic devices can include robotic devices, remote-controlled devices, personal-care appliances, and so on.

An “application” may include any software module configured to perform a specific function or functions when executed by a processor of a computer. For example, a “mobile application” may include a software module that is configured to be operated by a portable electronic device. Applications may be configured to perform many different functions. For example, a “point-of-sale” application may include a software module that is configured to enable a portable electronic device to act as a point-of-sale device. A “PIN encryption application” may include a software module that is configured to securely provide a PIN to an access device. An “application” may be computer code or other data stored on a computer readable medium (e.g., memory element or secure element) that may be executable by a processor to complete a task.

Referring again to FIG. 1, the user portable electronic device 106 may include one or more devices capable of receiving information from and/or transmitting information to the payment gateway system 102, the access device 104, the issuer system 108, the transaction service provider system 110, and/or the acquirer system 112 via the network 124. In some aspects, the user portable electronic device 106 may be similar to the portable electronic device 2000 of FIG. 10. The user portable electronic device 106 can include a processor and a memory. The memory can store a PIN encryption application 120 executable by the processor to enable the user portable electronic device 106 to generate an encrypted PIN to provide to the access device 104 for authenticating a transaction. In some aspects, the user portable electronic device 106 can be configured to receive information from the access device 104 via a communication connection (e.g., a near field communication (NFC) connection, a radio-frequency identification (RFID) communication connection, a Bluetooth® communication connection, and/or the like) and/or transmit information to the access device 104 and/or the payment card 116 via the communication connection. The user portable electronic device 106 can include a display screen configured to display information (e.g., the encrypted PIN) that a user may view and provide to the access device 104 (e.g., via a keypad of the access device, via a touch screen of the access device) to authenticate a transaction.

“Authentication” may refer to a process by which the credential of an endpoint (including but not limited to applications, users, devices, process, and systems) can be verified to ensure that the endpoint is who they are declared to be.

A “personal identification number” or “PIN” may refer to a numerical code or password shared between a user and a system to authenticate the user to the system. For example, a PIN may be issued or selected in association with a payment card and may be required to complete a transaction using the payment card. In some aspects, a PIN can include a range of four to six digits. A “PIN block” can be an encrypted block of data used to encapsulate a PIN. The PIN block may include the PIN, the PIN length, and a subset of a a persona account number (PAN).

Referring again to FIG. 1, the payment gateway system 102 may include one or more devices capable of receiving information from and/or transmitting information to the access device 104, the user portable electronic device 106, the issuer system 108, the transaction service provider system 110, and/or the acquirer system 112 via the network 124. For example, the payment gateway system 102 may include a computing device, such as a server (e.g., a transaction processing server), a group of servers, and/or other like devices.

A “payment gateway” may refer to an entity and/or a payment processing system operated by or on behalf of such an entity (e.g., a merchant service provider, a payment service provider (PSP), a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway and/or to a payment gateway itself.

Referring again to FIG. 1, the acquirer system 112 may include one or more devices capable of receiving information from and/or transmitting information to the payment gateway system 102, the POS device 104, the user portable electronic device 106, the issuer system 108, and/or the transaction service provider system 110 via the network 124. For example, the acquirer system 112 may include a computing device, such as a server, a group of servers, and/or other like devices. In some aspects, acquirer system 112 may be associated with an acquirer. In some aspects, the acquirer system 112 may be associated with a merchant account of a merchant associated with the POS device 104.

An “acquirer” may refer to an entity licensed by a transaction service provider and/or approved by a transaction service provider to originate transactions (e.g., payment transactions) using a portable financial device associated with the transaction service provider. “Acquirer” or “acquirer system” may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

Referring again to FIG. 1, the transaction service provider system 110 may include one or more devices capable of receiving information from and/or transmitting information to the payment gateway system 102, the access device 104, the user portable electronic device 106, the issuer system 108, and/or the acquirer system 112 via the network 124. For example, the transaction service provider system 110 may include a computing device, such as a server (e.g., a transaction processing server), a group of servers, and/or other like devices. In some aspects, the transaction service provider system 110 may be associated with a transaction service provider. In some aspects, transaction service provider system 110 may be in communication with a data storage device, which may be local or remote to the transaction service provider system 110. In some aspects, the transaction service provider system 110 may be capable of receiving information from, storing information in, transmitting information to, or searching information stored in a data storage device.

A “transaction service provider” may refer to an entity that receives transaction authorization requests from merchants or other entities and provides guarantees of payment, in some cases through an agreement between the transaction service provider and an issuer. For example, a transaction service provider may include a payment network, such as Visa®, MasterCard®, American Express®, or any other entity that processes transactions. As used herein “transaction service provider system” may refer to one or more systems operated by or operated on behalf of a transaction service provider, such as a transaction service provider system executing one or more software applications associated with the transaction service provider. In some non-limiting aspects, a transaction service provider system may include one or more server computers with one or more processors and, in some non-limiting aspects, may be operated by or on behalf of a transaction service provider.

Referring again to FIG. 1, the transaction service provider system 110 may include a hardware security module (HSM) 118. The HSM 118 can be a hardware device or computer configured to provide safeguards for storing, using, and/or generating security and cryptographic information such as, keys, digital certificates, passwords, passphrases, two-factor authentication information, PIN, tokens, and/or similar security and cryptographic information. The cryptographic information may be encrypted and/or decrypted by the HSM 118 using a cryptographic algorithm. In some aspects, the HSM 118 can be employed to generate, manage, and/or store keys. The HSM 118 may be configured as one or more than one stand-alone network computer and/or as one or more than one hardware card that may be added to a computer.

A “key” may refer to a piece of information that is used in a cryptographic algorithm to transform input data into another representation.

A “token” may refer to an account identifier that is used as a substitute or replacement for another account identifier, such as a PAN. Tokens may be associated with a PAN or other original account identifier in one or more data structures (e.g., one or more databases and/or the like) such that they may be used to conduct a payment transaction without directly using the original account identifier. In some non-limiting embodiments or aspects, tokens may be associated with a PAN or other account identifiers in one or more data structures such that they can be used to conduct a transaction without directly using the PAN or the other account identifiers. In some examples, an account identifier, such as a PAN, may be associated with a plurality of tokens for different uses or different purposes. A token may be a substitute value for a credential. A token may be a string of numbers, letters, or any other suitable characters. Examples of tokens include payment tokens, access tokens, personal identification tokens, etc.

A “cryptographic algorithm” can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc. Encryption techniques may include symmetric and asymmetric encryption techniques.

Referring again to FIG. 1, the issuer system 108 may include one or more devices capable of receiving information from and/or transmitting information to payment gateway system 102, the access device 104, the user portable electronic device 106, transaction service provider system 110, and/or the acquirer system 112 via the network 124. For example, issuer system 108 may include a computing device, such as a server, a group of servers, and/or other like devices. In various aspects, the issuer system 108 may be associated with an issuer institution. For example, the issuer system 108 may be associated with an issuer institution that issued a credit account, debit account, credit card account, debit card account, and/or the like to a user associated with the payment card 116.

The terms “issuer institution,” “portable financial device issuer,” “issuer,” or “issuer bank” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions), such as initiating credit and/or debit payments. For example, an issuer may provide an account identifier, such as a personal account number (PAN), to a user that uniquely identifies one or more accounts associated with the user. The account identifier may be used by the user to conduct a payment transaction. The account identifier may be embodied on a portable financial device, such as a physical financial instrument, e.g., a payment card, and/or may be electronic and used for electronic payments. As used herein “issuer system” or “issuer institution system” may refer to one or more systems operated by or operated on behalf of an issuer. For example, an issuer system may refer to a server executing one or more software applications associated with the issuer. In some non-limiting aspects of the present disclosure, an issuer system may include one or more servers (e.g., one or more authorization servers) for authorizing a payment transaction. An “issuer” can include a payment account issuer. The payment account (which may be associated with one or more payment devices) may refer to any suitable payment account (e.g., credit card account, a checking account, a savings account, a merchant account assigned to a consumer, or a prepaid account), an employment account, an identification account, an enrollment account (e.g., a student account), etc.

A “primary account number (PAN)” may be a variable length, (e.g., 13 to 19-digit) industry standard-compliant account number that is generated within account ranges associated with a bank identification number (BIN) by an issuer.

Referring again to FIG. 1, the network 124 may include one or more wired and/or wireless networks. For example, the network 124 may include a cellular network (e.g., a long-term evolution (LTE) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices, systems, and networks shown in the payment network environment 100 of FIG. 1 are provided as an example. There may be additional devices, systems, and/or networks, fewer devices, systems, and/or networks, different devices, systems, and/or networks, or differently arranged devices, systems, and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of the payment network environment 100 may perform one or more functions described as being performed by another set of devices of the payment network environment 100.

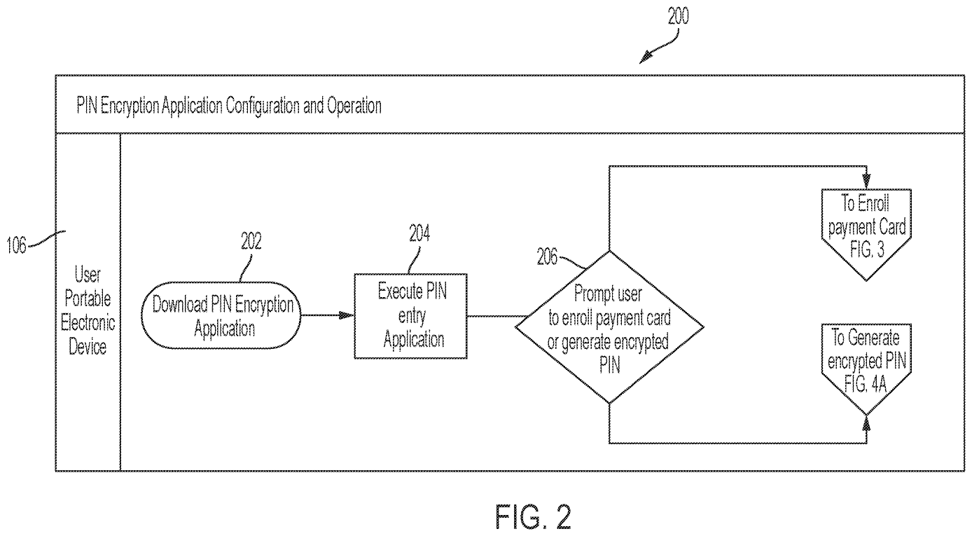

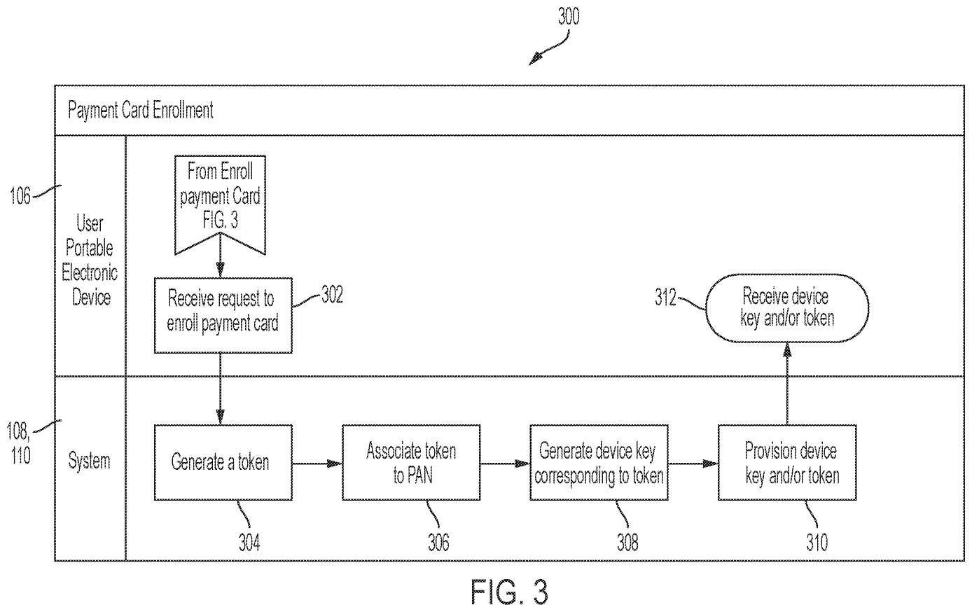

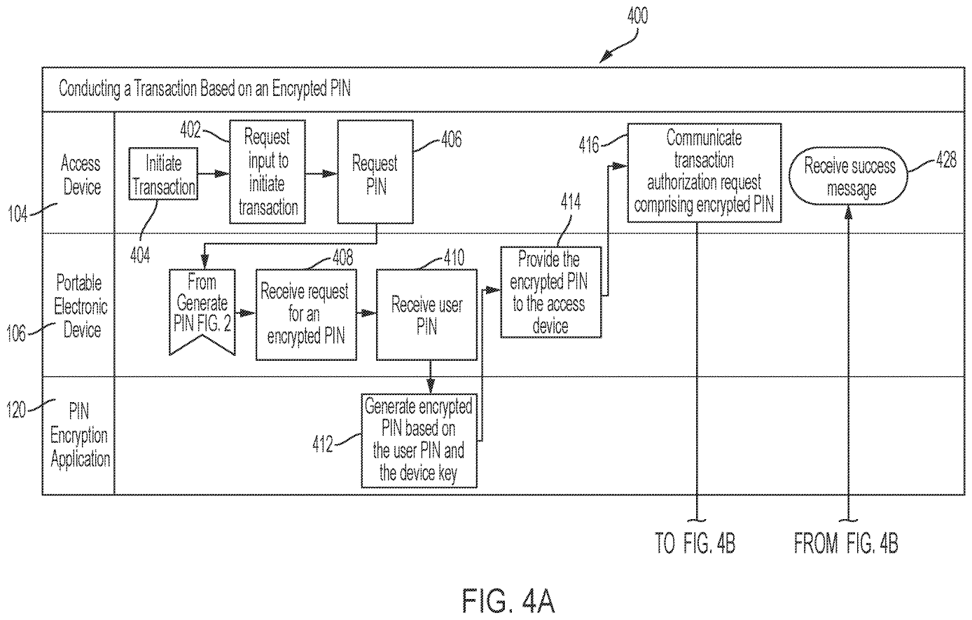

FIG. 2 is a swimlane diagram illustrating a method 200 for configuring and operating the personal identification number (PIN) encryption application 120 of FIG. 1, according to at least one aspect of the present disclosure. The method 200 can be carried out by the user portable electronic device 106 (FIG. 1).

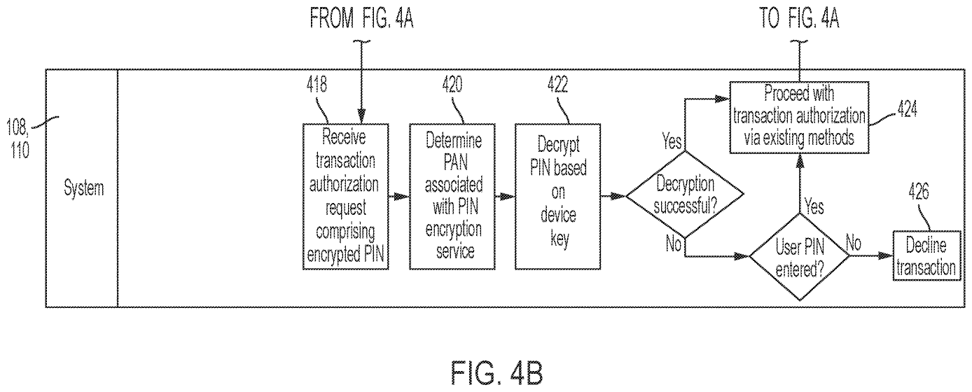

Referring primarily to FIG. 2, and also to FIG. 1, according to the method 200, the user portable electronic device 106 can download 202 the PIN encryption application 120. For example, based on receiving a user input, the user portable electronic device 106 can download the PIN encryption application 120 via the network 124 and install the PIN encryption application 120. As another example, the PIN encryption application 120 may already be installed on the portable electronic device 106 and thus the method 200 may not include downloading 202 the PIN encryption application 120. The user portable electronic device 106 can execute 204 (e.g., open) the PIN encryption application 120, for example, based on a user input selecting the PIN encryption application 120. Executing 204 the PIN encryption application 120 can cause the user portable electronic device 106 to prompt 206 the user to enroll a payment card 116 to the PIN encryption application 120 or generate an encrypted PIN. Prompting 206 the user can include displaying, by a display screen of the user portable electronic device 106, user-selectable options for enrolling the payment card 116 or generating the encrypted PIN. Enrolling the payment card 116 to the PIN encryption application 120 can be carried out according to the method 300 described below with respect to FIG. 3. Generating the encrypted PIN can be carried out according to the method 400 described below with respect to FIGS. 4A-4B.

FIG. 3 is a swimlane diagram illustrating a method 300 for enrolling a payment card 116 to the PIN encryption application 120, according to at least one aspect of the present disclosure. The method 300 can be carried out by the user portable electronic device 106 and the issuer system 108 or the transaction service provider system 110 (FIG. 1). A “system 108, 110” is sometimes used herein to refer to the issuer system 108 and/or the transaction service provider system 110.

Referring primarily to FIG. 3, and also to FIG. 1, according to the method 300, the user portable electronic device 106 can receive 302 a request to enroll a payment card 116. For example, a user may provide an input to the user portable electronic device 106 requesting to enroll a payment card 116. In some aspects, receiving 302 the request to enroll the payment card can include receiving various account credentials associated with the payment card 116 (e.g., an account identifier, an expiration date, a verification value, a user PIN, etc.) that enable the PIN encryption application 120 to recognize the payment card 116, verify that the payment card 116 is associated with the user, and/or store the account credentials associated with the payment card 116 to the memory of the user portable electronic device 106. In some aspects, the PIN encryption application 120 recognizes the payment card 116, verifies that the payment card 116 is associated with the user, and/or stores the account credentials associated with the payment card 116 based on a user input and/or based on a communication with the issuer system 108 and/or the transaction service provider system 110.

According to some aspects of the present disclosure, the PIN encryption application 120 may not be configured to store a user PIN associated with payment card 116. According to other aspects of the present disclosure, the PIN encryption application 120 can be configured to store (e.g., encrypt and store) a user PIN associated with payment card 116 to the user portable electronic device 106. As explained further herein, the PIN encryption application 120 can be configured to generate an encrypted PIN based on the user PIN. The PIN encryption application 120 can be configured to retrieve the stored user PIN in order to generate an encrypted PIN. In one aspect, the PIN encryption application 120 can be configured to require the user to provide a password and/or a biometric authentication in order to retrieve the stored user PIN and generate the encrypted PIN. For example, more than one payment card 116 may be enrolled to the PIN encryption application 120. The PIN encryption application 120 can be configured to enable the user to set up a master PIN and/or password. The master PIN and/or password can be different from stored user PIN(s) associated with each enrolled payment card 116. The PIN encryption application 120 can retrieve the stored user PIN(s) based on the user providing the master PIN and/or password. As another example, the PIN encryption application 120 can be configured to enable the user to require that user biometric authentication be provided in order to retrieve the user stored PIN(s). After the user choses to require biometric authentication, the PIN encryption application 120 can be configured retrieve the stored user PIN(s) based on the user providing biometric authentication (e.g., via a fingerprint scan, via a facial scan).

Referring still primarily to FIG. 3, and also to FIG. 1, according to the method 300, the system 108, 110 can generate 304 a token, for example, based on the user portable electronic device 106 receiving 302 the request to enroll the payment card 116. The system 108, 110 can associate 306 the token to a personal account number (PAN) corresponding to the payment card 116. Further, the system 108, 110 can generate 308 a device key (e.g., an encryption key) that corresponds to the token. The system 108, 110 provisions 310 the device key and/or the token to the user portable electronic device 106. In some aspects, provisioning 310 the device key and/or the token to the user portable electronic device 106 can include communicating the device key and/or the token to the user portable electronic device 106 through a secured communication channel (e.g., via a secure sockets layer (SSL) protocol, via a transport layer security protocol (TS), based on encryption using device hardware public key). The user portable electronic device 106 can receive 312 the device key and/or the token. As explained further herein, an encrypted PIN can be generated by the PIN encryption application based on the device key received 312 by the user portable electronic device 106.

FIGS. 4A-4B show a swimlane diagram illustrating a method 400 for conducting a transaction based on an encrypted PIN, according to at least one aspect of the present disclosure. The method 400 can be carried out by an access device 104, the user portable electronic device 106, the payment card 116, the PIN encryption application 120, and the system 108, 110 (e.g., the issuer system or the transaction service provider system 110).

Referring primarily to FIGS. 4A-4B, and also to FIG. 1, according to the method 400, the access device 104 can request 402 an input to initiate a transaction. For example, the access device 104 may be a POS device 114, such as a merchant portable electronic device executing a point-of-sale application 122, that is displaying a checkout screen for initiating a transaction between a merchant and a user. The checkout screen may include a notification requesting 402 that the user tap, dip, and/or swipe a payment card 116 to initiate a transaction. As another example, the access device 104 may be an ATM displaying a transaction screen that includes a request 402 for a user to provide a payment card 116 to initiate a transaction.

Referring still primarily to FIGS. 4A-4B, and also to FIG. 1, according to the method 400, the access device 104 may receive an input to initiate 404 a transaction. For example, where the access device 104 is a POS device 114, such as a merchant portable electronic device executing a point-of-sale application 122, a user may tap or otherwise place the payment card 116 proximate to the a wireless reader of the POS device 114 to initiate 404 a transaction (e.g., a tap-to-phone (TTP) transaction). As another example, a user may dip the payment card 116 into a reader of the access device 104 or swipe the payment card 116 across a reader of the access device 104 to initiate 404 a transaction.

Referring still primarily to FIGS. 4A-4B, and also to FIG. 1, according to the method 400, the access device 104 can request 406 a PIN. For example, a value of the initiated 404 transaction may satisfy a predetermined threshold, thereby triggering the requirement for a PIN in order to proceed. As another example, the initiated 404 transaction may require strong customer authentication (SCA) and therefore require a PIN. In some aspects, a display screen of the access device 104 may display the request 406 for the user to provide a PIN. For example, where the access device 104 is a POS device 114, such as a merchant portable electronic device executing a point-of-sale application 122, the display screen may be a touch screen displaying a keypad for the user to type a PIN. As another example, a display screen of the access device 104 may instruct the user to enter a PIN on separate hardware (e.g., physical keypad) associated with the access device 104.

Referring still primarily to FIGS. 4A-4B, and also to FIG. 1, according to the method 400, the user portable electronic device 106 can receive 408 a request for an encrypted PIN to authenticate the transaction. The request can be, for example, from a user who has just viewed the access device 104 display the request 406 for a PIN. The user portable electronic device 106 can receive 408 the user's request for an encrypted PIN based on a user input received 408 by a touch screen of the user portable electronic device 106.

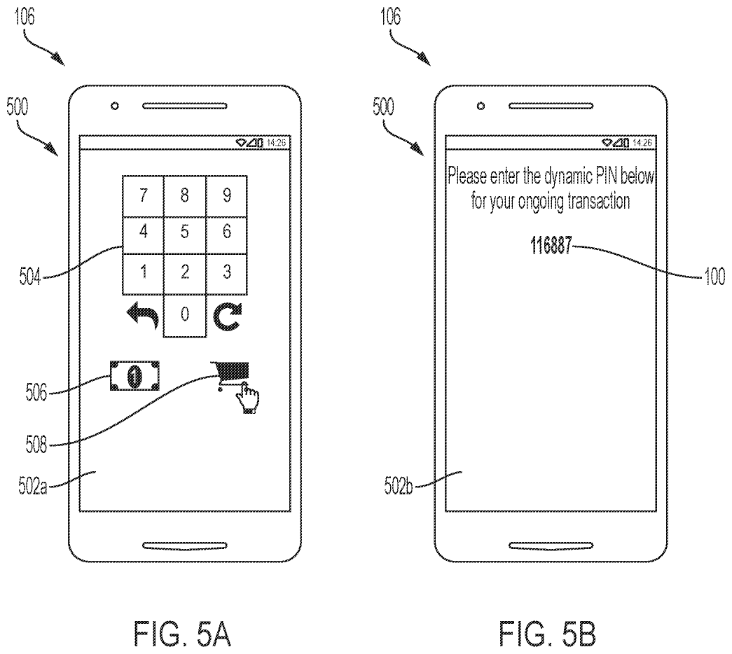

Referring still primarily to FIGS. 4A-4B, and also to FIG. 1, according some aspects of the method 400, the user portable electronic device can also receive 410 a user PIN. For example, FIG. 5A illustrates a display screen 500 of the user portable electronic device 106 displaying a user interface 502a generated by the PIN encryption application 120. The user interface 502a may include a keypad 504. The user may provide the user PIN via the keypad 504. This method of receiving 410 the user PIN may be applied, for example, in cases where the PIN corresponding to the payment card 116 is not already stored to the user portable electronic device 106 by the PIN encryption application 120.

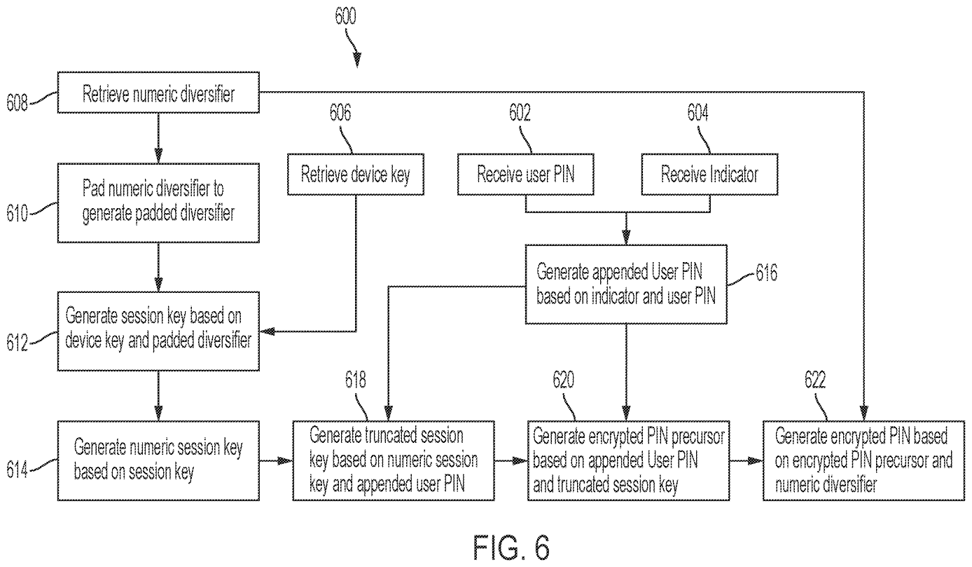

According to at least one aspect of the method 400, the user portable electronic device 106 can also receive an indicator based on a type of the transaction for which the encrypted PIN is being requested. For example, the received indicator can correspond to a retail transaction with a merchant. As another example, the received indicator can correspond to a cash withdrawal from the access device 104 (e.g., an ATM). Indicators for other types of transactions are also contemplated by the present disclosure. For example, the user portable electronic device 106 can receive an indicator corresponding to a high-value transaction (e.g., greater than or equal to $50), a low-value transaction (e.g., less than $50), a domestic transaction, an international transaction, etc. As explained further with respect to FIG. 6, the indicator can be a numeric value that correlates to a transaction type.

Referring again to FIG. 5A, the user interface 502a generated by the PIN encryption application 120 may include one or more than one selectable icon allowing the user to indicate a transaction type of the initiated transaction. For example, the icon 506 can be selected to indicate that the transaction is a cash withdrawal. The icon 508 can be selected to indicate that the transaction is a retail transaction. The user portable electronic device 106 may receive the above-mentioned indicator based on the user selecting one of the icons 506, 508.

Referring again primarily to FIGS. 4A-4B, and also to FIG. 1, according some aspects of the method 400, receiving 410 the user PIN can include retrieving a stored PIN. For example, as explained above, the PIN encryption application 120 can be configured to store the user PIN to the user portable electronic device 106. Based on receiving a password, a master PIN, and/or a user biometric authentication, the user portable electronic device 106 can retrieve the stored PIN.

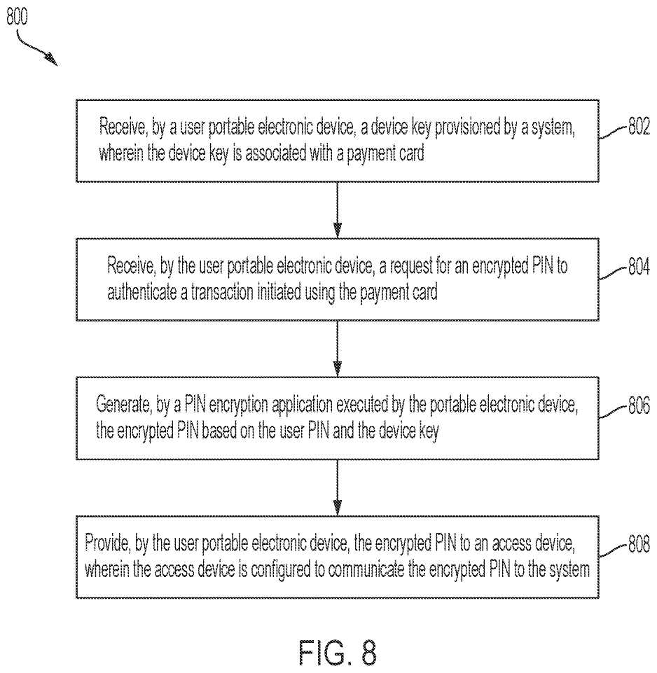

Referring still primarily to FIGS. 4A-4B, and also to FIG. 1, according to the method 400, the PIN encryption application 120 can generate 412 the encrypted PIN based on the user PIN and a device key (e.g., the device key received 312 by the user portable electronic device 106, as explained above with respect to FIG. 3). In some aspects, the encrypted PIN can also be generated based on the indicator. In some aspects, the encrypted PIN can be generated 412 according to the method 600 described below with respect to FIG. 6. In some aspects, the encrypted PIN can be generated 412 according to the method 800 (e.g., generating 806 an encrypted PIN) described below with respect to FIG. 8.

Referring still primarily to FIGS. 4A-4B, and also to FIG. 1, according to the method 400, the user portable electronic device 106 provides 414 the encrypted PIN to the access device 104. In one aspect, providing 414 the encrypted PIN to the access device 104 can include displaying the encrypted PIN on a display screen of the user portable electronic device 106, thereby allowing the user to read the encrypted PIN and provide the encrypted PIN to the access device 104. For example, FIG. 5B illustrates a display screen 500 of the user portable electronic device 106 displaying a user interface 502b generated by the PIN encryption application 120. The user interface 502b is displaying the encrypted PIN 510 generated 412 by the PIN encryption application 120 for the user to view. Returning to FIGS. 1 and 4A-4B, the user may provide 414 the encrypted PIN to the access device 104 by typing the encrypted PIN on a keypad and/or a touch screen of the access device 104. In another aspect, providing 414 the encrypted PIN to the access device 104 can include wirelessly transmitting, by the user portable electronic device 106, a message comprising the encrypted PIN to the access device 104.

Referring still primarily to FIGS. 4A-4B, and also to FIG. 1, according to the method 400, the access device 104 can communicate 416 a transaction authorization request comprising the encrypted PIN to the system 108, 110. In some aspects, the transaction authentication request is communicated 416 to the system 108, 110 via the payment gateway system 102, the acquirer system 112, and/or the transaction service provider system 110. The encrypted PIN can be configured according to International Organization for Standardization (ISO) PIN block format. Thus, the transaction authorization request communicated 416 to system 108, 110 can be compliant with payment network communication standards that are currently in use.

Referring still primarily to FIGS. 4A-4B, and also to FIG. 1, according to the method 400, the system 108, 110 receives 418 the transaction authorization request comprising the encrypted PIN. The transaction authentication request received 418 by the system 108, 110 corresponds to the payment card 116 and can include a personal account number (PAN) and/or be associated with the personal account number (PAN) by the system 108, 110. The system 108, 110 can extract the PAN from the transaction authentication request or otherwise determine the PAN based on the transaction authentication request.

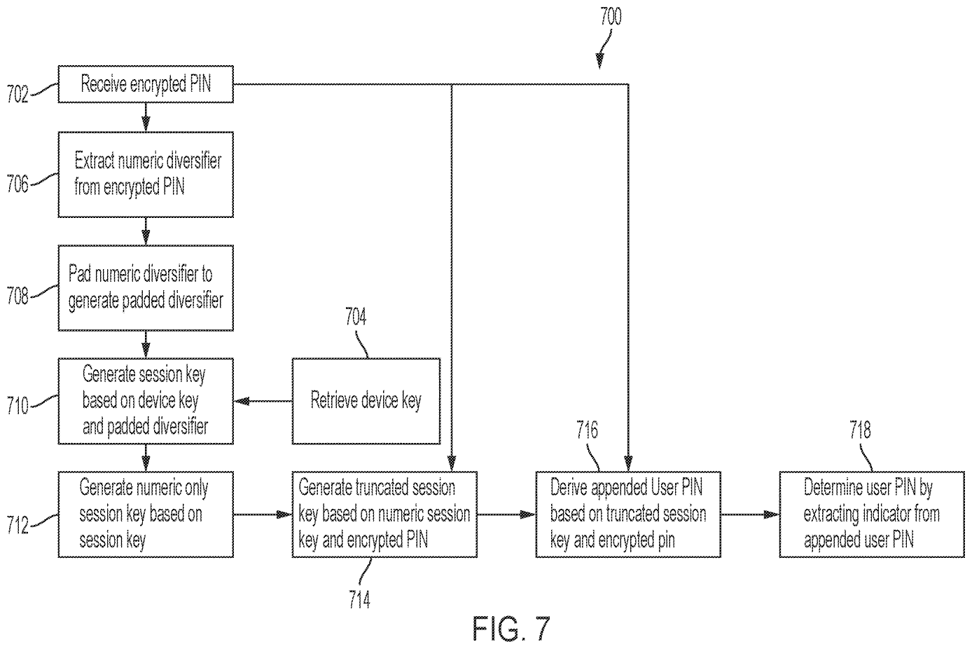

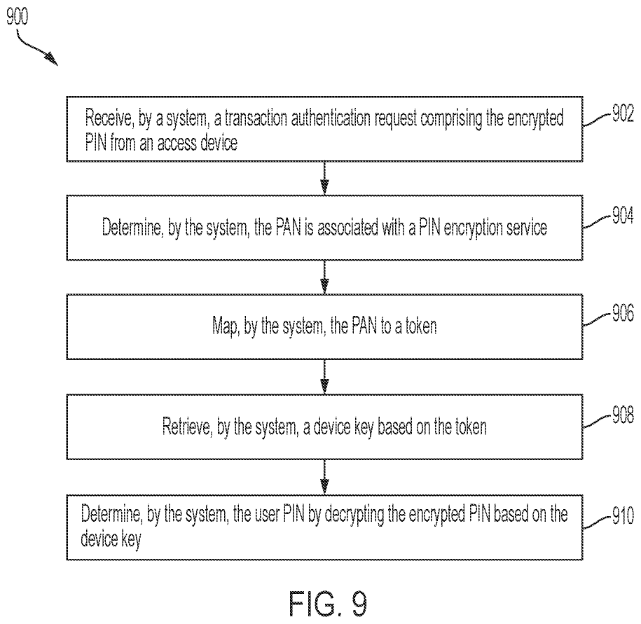

Referring still primarily to FIGS. 4A-4B, and also to FIG. 1, according to the method 400, the system 108, 110 can determine 420 that the PAN is associated with a PIN encryption service. For example, the system 108, 110 may determine that the PAN is associated with a payment card 116 that has been enrolled to the PIN encryption application 120 (e.g., according to the method 300 of FIG. 3). Based on determining 420 that the PAN is associated with a PIN encryption service, the system 108, 110 can decrypt 422 (e.g., attempt to decrypt 422) the encrypted PIN based on the device key. The device key used to decrypt 422 the encrypted PIN can be the same device key provisioned 310 (FIG. 3) to the user portable electronic device 106 by the system 108, 110 and used by the PIN encryption application 120 to generate 412 the encrypted PIN. In some aspects, the system 108, 110 can decrypt 422 the PIN according to the method 700 described below with respect to FIG. 7. In some aspects, the system 108, 110 can decrypt 422 the PIN according to the method 900 described below with respect to FIG. 9.

Referring still primarily to FIGS. 4A-4B, and also to FIG. 1, according to the method 400, the system 108, 110 can either proceed 424 with authorizing the transaction or decline 426 the transaction depending upon whether the decryption 422 was successful. For example, if a valid encrypted PIN was generated 412 by the PIN encryption application 120, then decrypting 422 the encrypted PIN can result in the system 108, 110 determining the user PIN. The system 108, 110 can then proceed 424 with authorizing the transaction according to existing methods. This may include determining whether the user PIN is valid and/or determining whether other transaction-related considerations are satisfied (e.g., sufficient funds, etc.). Upon approving the transaction, the system 108, 110 can send a success message that is received 428 by access device 104.

As another example, the decryption 422 may not be successful because the user PIN, rather than an encrypted PIN generated 412 based on the user PIN, was provided 414 to the access device 104. In one aspect, the system 108, 110 can decline 426 the transaction based on determining the user PIN was provided 414 instead of the encrypted PIN. This may serve to prevent fraud in situations where a fraudster has stolen the user PIN and the payment card 116 but does not have the ability to generate the encrypted PIN. In another aspect, the system 108, 110 can verify the user PIN based on determining that the user PIN was provided 414 instead of the encrypted PIN and proceed 424 with the transaction authorization according to existing methods. This may serve to provide convenience to the user, for example, in cases where the user has forgotten to use the PIN encryption application 120 to generate 412 an encrypted PIN and in cases where the user, at least temporarily, does not have access to the user portable electronic device 106 and/or the PIN encryption application 120.

As noted above, according to some aspects of the method 400, the encrypted PIN may be generated 412 based on an indicator that corresponds to a transaction type. In these aspects, the system 108, 110 can be configured to extract the indicator from the encrypted PIN. The system 108, 110 can further determine the transaction type of the transaction based on communicating with the access device 104. The system 108, 110 can then compare the transaction type determined based on communicating with the access device 104 to the indicator extracted based on the encrypted PIN. The system 108, 110 can be configured to decline 426 the transaction if the transaction type determined based on communicating with the access device 104 does not correspond to the indicator extracted based on the encrypted PIN.

According to some aspects of the method 400, the user portable electronic device 106 can transmit a geolocation of the user portable electronic device 106 to the system 108, 110. The system 108, 110 can be configured to compare the geolocation of the user portable electronic device 106 to a geolocation of the access device 104. In some aspects, the system 108, 110 can be configured to decline 426 the transaction if the geolocation of the user portable electronic device 106 does not correspond to a geolocation of the access device 104.

FIG. 6 is a flow diagram of a method 600 for generating an encrypted PIN based on a user PIN, according to at least one aspect of the present disclosure. The method 600 can be executed by the user portable electronic device 106 and/or the PIN encryption application 120 described above with respect to FIG. 1. To better describe various aspects of the method 600, an illustrative example of the inputs received and outputs generated by the method 600 is provided below. The method 600 is not limited to these example inputs and outputs.

Referring primarily to FIG. 6, and also to FIG. 1, the user portable electronic device 106 receives 602 the user PIN and receives 604 an indicator. In some aspects, the user PIN can include four to six digits (e.g., four to six numerical digits). The indicator can be a numeric value that correlates to a transaction type, such as, for example, a retail transaction, a high-value transaction (e.g., greater than or equal to $50), a low-value transaction (e.g., less than $50), a domestic transaction, an international transaction, etc. In some aspects, the indicator may be a single numeric digit. The user PIN and the indicator may be received 602, 604 based on a user input to the user portable electronic device 106 (e.g., via the user interface 502a described above with respect to FIG. 5A). As an illustrative example, the received 602 the user PIN may be “1234.” Further, the received 604 indicator may be “8,” which may correspond to a retail transaction type.

Still referring primarily to FIG. 6, and also to FIG. 1, according to the method 600, the PIN encryption application 120 retrieves 606 a device key. The device key may be provisioned by a system 108, 110 (e.g., as explained above with respect to the method 300 of FIG. 3). In some aspects, the device key can be a 16-byte alpha numeric string generated by the system 108, 110. Continuing with the illustrative example, the retrieved 606 device key may be “0x00112233445566778899aabbccddeeff.”

Still referring primarily to FIG. 6, and also to FIG. 1, according to the method 600, the PIN encryption application 120 retrieves 608 a numeric diversifier. The numeric diversifier may be retrieved 608 from a set of numeric diversifiers. The set of numeric diversifiers may be provisioned by a system 108, 110 and/or may be provided by the PIN encryption application 120. In some aspects, the PIN encryption application 120 may cycle through the set of numeric diversifiers such that such that a different numeric diversifier is retrieved 608 from the set of numeric diversifiers the next time method 600 is carried out to generate an encrypted PIN. The set of numeric diversifiers can be ordered sequentially (e.g., 0, 1, 2, 3, 4, 5, . . . ) or in a randomized, non-repeating sequence (e.g., 7, 3, 4, 0, . . . ). In some aspects, upon cycling through each numeric diversifier of the set of diversifiers, the PIN encryption application 120 can cause the user portable electronic device 106 to request that a new device key be provisioned by the system 108, 110. In other aspects, the system 108, 110 may track a numeric diversifier count that is cycled based on each time the system 108, 110 decrypts an encrypted PIN. Further, the system 108, 110 may provision a new device key to the PIN encryption application 120 based on the numeric diversifier count reaching a predetermined threshold (e.g., based on the count indicating the PIN encryption application 120 has cycled through each numeric diversifier of the set of numeric diversifiers). Continuing with the illustrative example, the retrieved 608 numeric diversifier may be “7.”

Still referring primarily to FIG. 6, and also to FIG. 1, according to the method 600, the numeric diversifier is padded 610 to generate a padded diversifier. For example, the numeric diversifier may be padded to an 8-byte alpha numeric string. Continuing with the illustrative example, the numeric diversifier “7” may be padded 610 to the 8-byte alphanumeric string padded diversifier “0x0700007070FFFF07.”

Still referring primarily to FIG. 6, and also to FIG. 1, according to the method 600, a session key is generated 612 based on the device key and the padded diversifier. The session key may be generated 612 using a triple data encryption standard (TDES) algorithm key. Continuing with the illustrative example, inputting the 8-byte alphanumeric padded diversifier “0x0700007070FFFF07” and the 16-byte alphanumeric device key “0x00112233445566778899aabbccddeeff” into a TDES algorithm can generate 612 the session key “F3785CFFFE57B353” (e.g., TDES_ENC(Key, Diversifier)=F3785CFFFE57B353).

Still referring primarily to FIG. 6, and also to FIG. 1, according to the method 600, a numeric session key is generated 614 based on the session key. The numeric session key can be generated 614 by performing a modulo operation on the session key with the divisor “0x0a.” Continuing with the illustrative example, performing a modulo operation on the session key “F3785CFFFE57B353” with “0x0a” can generate 614 the numeric session key “30454793.”

Still referring primarily to FIG. 6, and also to FIG. 1, according to the method 600, an appended user PIN can be generated 616 based on the indicator and the user PIN. For example, the indicator may be inserted at the beginning or the end of the user PIN to generate 616 the appended user PIN. Continuing with the illustrative example, the indicator “8” may be inserted at the beginning of the user PIN “1234” to generate 616 the appended user PIN “81234.”

Still referring primarily to FIG. 6, and also to FIG. 1, according to the method 600, a truncated session key can be generated 618 based on the numeric session key and the appended user PIN. For example, the numeric session key can be truncated to have the same number of digits as the appended user PIN. Continuing with the illustrative example, the appended user PIN “81234” has five digits. Thus, the numeric session key “30454793” can be truncated to five digits to generate 618 the truncated session key “30454.”

Still referring primarily to FIG. 6, and also to FIG. 1, according to the method 600, an encrypted PIN precursor can be generated 620 based on the appended user PIN and the truncated session key. For example, the encrypted PIN precursor can be generated by adding the appended user PIN to the truncated session key, digit by digit, ignoring the carrier, to generate an encrypted PIN precursor with the same number of digits as the appended user PIN and the truncated session key. Continuing with the illustrative example, the appended user PIN “81234” can be added digit by digit to the truncated session key “30454,” ignoring the carrier, to generate 620 the encrypted PIN precursor “11688.”

Still referring primarily to FIG. 6, and also to FIG. 1, according to the method 600, the encrypted PIN can be generated 622 based on the encrypted PIN precursor and the numeric diversifier. For example, the numeric diversifier can be inserted at the end or the beginning of the encrypted PIN precursor to generate 622 the encrypted PIN. Continuing with the illustrative example, inserting the numeric diversifier “7” at the end of the encrypted PIN precursor 11688 generates the encrypted PIN “116887.”

According to one aspect of the method, an indicator may not be implemented. In this aspect, no appended user PIN is generated 618, the truncated session key is generated 618 based on the number of digits of the user PIN, and the encrypted PIN precursor is generated 620 based on the user PIN and the truncated session key.

FIG. 7 is a flow diagram of a method 700 for decrypting an encrypted PIN to determine a user PIN, according to at least one aspect of the present disclosure. The method 700 can be executed by the system 108, 110 described above with respect to FIG. 1. To better describe various aspects of the method 700, an illustrative example of the inputs received and outputs generated by the method 700 are provided below. The method 700 is not limited to these example inputs and outputs.

Referring primarily to FIG. 7, and also to FIG. 1, according to the method 700, the system 108, 110 receives 702 an encrypted PIN. The encrypted PIN may be a numeric string that is generated based on a user PIN (e.g., according to the method 600 of FIG. 6). As an illustrative example, the system 108, 110 may receive 702 the encrypted PIN “116887” (e.g., the encrypted PIN generated based on the illustrative example described above with respect to the method 600 of FIG. 6).

Still referring primarily to FIG. 7, and also to FIG. 1, according to the method 700, the system 108, 110 can retrieve 704 a device key. The device key may be stored by the system 108, 110 and may correspond to a device key that has been provisioned by the system 108, 110 to a user portable electronic device 106 as part of a PIN encryption service (e.g., as explained above with respect to the method 300 of FIG. 3). Thus, the device key may be a symmetric key. In some aspects, the device key can be a 16-byte alpha numeric string generated by the system 108, 110. Continuing with the illustrative example, the retrieved 704 device key may be “0x00112233445566778899aabbccddeeff.”

Still referring primarily to FIG. 7, and also to FIG. 1, according to the method 700, the system 108, 110 can extract 706 a numeric diversifier from the encrypted PIN. For example, a numeric diversifier may be inserted at the end or the beginning of the encrypted PIN. Thus, the system 108, 110 may extract 706 the numeric diversifier based on a predetermined placement of the numeric diversifier within the encrypted PIN. Continuing with the illustrative example, the numeric diversifier “7” may be extracted 706 from the end of the encrypted PIN the encrypted PIN “116887.”

Still referring primarily to FIG. 7, and also to FIG. 1, according to the method 700, the system 108, 110 can pad 708 the extracted 706 numeric diversifier to generate a padded diversifier. For example, the numeric diversifier may be padded to an 8-byte alpha numeric string. Continuing with the illustrative example, the numeric diversifier “7” may be padded 708 to the 8-byte alphanumeric string padded diversifier “0x0700007070FFFF07.”

Still referring primarily to FIG. 7, and also to FIG. 1, according to the method 700, the system 108, 110 can generate 710 a session key based on the device key and the padded diversifier. The session key may be generated 710 using a triple data encryption standard (TDES) algorithm key (e.g., the same algorithm used to generate 612 the session key as described above with respect to the method 600 of FIG. 6). Continuing with the illustrative example, inputting the 8-byte alphanumeric padded diversifier “0x0700007070FFFF07” and the 16-byte alphanumeric device key “0x00112233445566778899aabbccddeeff” into a TDES algorithm can generate 710 the session key “F3785CFFFE57B353” (e.g., TDES_ENC(Key, Diversifier)=F3785CFFFE57B353).

Still referring primarily to FIG. 7, and also to FIG. 1, according to the method 700, the system 108, 110 can generate 712 a numeric session key based on the session key. The numeric session key can be generated 712 by performing a modulo operation on the session key with the divisor “0x0a.” Continuing with the illustrative example, performing a modulo operation on the session key “F3785CFFFE57B353” with “0x0a” can generate 712 the numeric session key “30454793.”

Still referring primarily to FIG. 7, and also to FIG. 1, according to the method 700, the system 108, 110 can generate 714 a truncated session key based on the numeric session key and the encrypted PIN. For example, the numeric session key can be truncated to have one less digit than the encrypted PIN (e.g., the same number of digits remaining in the encrypted PIN after the numeric diversifier has been extracted 706). Continuing with the illustrative example, the encrypted PIN “116887” has six digits (and five digits after the numeric diversifier “7” is extracted from the end of the encrypted PIN). Thus, the numeric session key “30454793” can be truncated to five digits to generate 714 the truncated session key “30454.”

Still referring primarily to FIG. 7, and also to FIG. 1, according to the method 700, the system 108, 110 can derive 716 an appended user PIN based on the truncated session key and the encrypted PIN. For example, the appended user PIN can be derived by subtracting the truncated session key from the encrypted PIN (after the numeric indicator is extracted from the encrypted PIN), digit by digit, ignoring the carrier. Continuing with the illustrative example, the appended user PIN “81234” can be derived 716 by subtracting the truncated session key “30454” from the encrypted PIN “11688” (after the numeric indicator is extracted from the encrypted PIN), digit by digit, ignoring the carrier.

Still referring primarily to FIG. 7, and also to FIG. 1, according to the method 700, the system 108, 110 can determine 718 the user PIN by extracting the indicator from the appended user PIN. For example, as explained above with respect to the method 600 of FIG. 6, an appended user PIN may be generated 616 by the user portable electronic device 106 by inserting an indicator at the beginning or the end of the user PIN. Thus, returning to FIG. 7, system 108, 110 can extract the indicator from the appended user PIN based on a predetermined placement of the indicator in the appended user PIN. Continuing with the illustrative example, the indicator “8” may be extracted from the beginning of the appended user PIN “81234” to determine 718 the user PIN “1234.” As explained further herein, the user PIN and/or the extracted indicator can be verified by the system 108, 110 to authenticate a transaction.

FIG. 8 is a flow diagram of a method 800 for securely providing a PIN, according to at least one aspect of the present disclosure. The method 800 may be carried out by a user portable electronic device, such as the user portable electronic device 106 of FIG. 1. As described further herein with respect to FIGS. 1-4, the user portable electronic device 106 can communicate with a system 108, 110, such as a transaction service provider system 110 or an issuer system 108. A user may own or otherwise be associated with the user portable electronic device 106 and a payment card 116. A transaction may be initiated using the payment card 116 and an access device 104. The transaction may require a user PIN for authenticating the user. The user portable electronic device 106 can execute a PIN encryption application 120.

Referring primarily to FIG. 8, and also to FIG. 1, according to the method 800, the user portable electronic device 106 receives 802 a device key provisioned by the system 108, 110. The device key can be associated with the payment card 116.

Referring still primarily to FIG. 8, and also to FIG. 1, according to the method 800, the user portable electronic device 106 receives 804 a request for an encrypted PIN to authenticate the transaction initiated using the payment card 116. The request can be, for example, based on a user input received 804 by a touch screen of the user portable electronic device 106.

Referring still primarily to FIG. 8, and also to FIG. 1, according to the method 800, the PIN encryption application 120 generates 806 an encrypted PIN based on the user PIN and the device key.

Referring still primarily to FIG. 8, and also to FIG. 1, according to the method 800, the user portable electronic device 106 provides 808 the encrypted PIN to the access device 104. In one aspect, providing 808 the encrypted PIN to the access device 104 can include displaying the encrypted PIN on a display screen of the user portable electronic device 106 (e.g., similar to FIG. 5B described above), thereby allowing the user to read the encrypted PIN and provide the encrypted PIN to the access device 104. The user may provide the encrypted PIN to the access device 104 by typing the encrypted PIN on a keypad and/or a touch screen of the access device 104. In another aspect, providing 808 the encrypted PIN to the access device 104 can include wirelessly transmitting, by the user portable electronic device 106, a message comprising the encrypted PIN to the access device 104. The access device 104 can be configured to communicate the encrypted PIN to the system 108, 110.

According to some aspects of the method 800, the encrypted PIN can be generated 806 based on the user PIN, the device key, and a set of numeric diversifiers. For example, the PIN encryption application 120 can retrieve a first numeric diversifier from a set of numeric diversifiers. The PIN encryption application 120 can generate a first session key based on the device key and the first numeric diversifier and can further generate the encrypted PIN based on the first session key. In at least one aspect of the method 800, the user portable electronic device can generate the encrypted PIN according to the method 600 described with respect to FIG. 6. Based on receiving the encrypted PIN, the system 108, 110 can be configured to extract the first numeric diversifier from the encrypted PIN, generate the first session key based on the device key and the first numeric diversifier, and decrypt the encrypted PIN based on the first session key.

In one of the above aspects of the method 800, the device key can include a 16-byte alphanumeric string. The PIN encryption application 120 can pad the first numeric diversifier to generate a padded diversifier. The padded diversifier can include an 8-byte alphanumeric string. The PIN encryption application 120 can then derive the first session key based on the 16-byte device key and the 8-byte padded diversifier, generate a numeric session key based on the first session key, and generate a truncated numeric session key by truncating the numeric session key. The truncated numeric session key can have a string length equal to a string length of the user PIN. The PIN encryption application 120 can then generate the encrypted PIN by sequentially adding each digit of the truncated numeric session key to a corresponding digit of the user PIN.

In another one of the above aspects of the method 800, the transaction can be a first transaction and the encrypted PIN can be a first encrypted PIN. According to this aspect, the user portable electronic device 106 can store the set of numeric diversifiers. The PIN encryption application 120 can retrieve a second numeric diversifier from the set of numeric diversifiers and generate a second session key based on the device key and the second numeric diversifier. Further, the PIN encryption application 120 can generate a second encrypted PIN based on the second session key. The second encrypted PIN can be used for authenticating a second transaction.

According to another aspect of the method 800, the user portable electronic device 106 can receive a new device key provisioned by the system 108, 110 based on a count corresponding to the set of numeric diversifiers reaching a predetermined threshold. For example, the user portable electronic device 106 can receive a new device key after each numeric diversifier of the set of numeric diversifiers have been used to generate an encrypted PIN.

According to another aspect of the method 800, the encrypted PIN is generated 806 based on the user PIN and the device key without the user portable electronic device 106 being connected to the network 124.

According to another aspect of the method 800, the PIN encryption application can receive a user input designating a transaction type of the transaction and generate the encrypted PIN based on an indicator corresponding to the transaction type. The system 108, 110 can be configured to extract the indicator from the encrypted PIN and compare the indicator to a transaction type identified based on communicating with the access device 104.

According to another aspect of the method 800, receiving 802 the request for the encrypted PIN can include receiving, by the user portable electronic device 106, the user PIN, a passcode, or a user biometric authentication, or a combination thereof.

According to another aspect of the method 800, the user portable electronic device 106 can transmit a geolocation of the user portable electronic device 106 to the system 108, 110. The system 108, 110 can be configured to compare the geolocation of the user portable electronic device 106 to a geolocation of the access device 104. In some aspects, the system 108, 110 can be configured to decline the transaction if the geolocation of the user portable electronic device 106 does not correspond to a geolocation of the access device 104.

According to another aspect of the method 800, the access device 104 is a merchant portable electronic device executing the point-of-sale application 122.

FIG. 9 is a flow diagram of a method 900 for authenticating a transaction, according to at least one aspect of the present disclosure. The method 900 may be carried out by a server, such as, one or more than one server of the system 108, 110, which can include the transaction service provider system 110 or the issuer system 108. As described further herein with respect to FIGS. 1-4, a transaction may be initiated using a payment card 116 and an access device 104. The transaction may require user authentication based on a user PIN. The system 108, 110 can be in communication with an acquirer system 112.

Referring primarily to FIG. 9, and also to FIG. 1, according to the method 900, the system 108, 110 receives 902 a transaction authentication request comprising the encrypted PIN from the access device 104. The transaction authentication request corresponds to the payment card 116 and is associated with a personal account number (PAN). In some aspects, receiving 902 the transaction authentication request from the access device 104 can include receiving the transaction authentication via an acquirer system 112, wherein the access device 104 communicates the transaction authentication request to the acquirer system 112 or a payment gateway system 102.

Referring still primarily to FIG. 9, and also to FIG. 1, the system 108, 110 determines 904 that the PAN is associated with a PIN encryption service. For example, the system 108, 110 may determine that the PAN is associated with a payment card 116 that has been enrolled to the PIN encryption application 120 (e.g., according to the method 300 of FIG. 3). The system 108, 110 further maps 906 the PAN to a token and retrieves 908 a device key based on the token. Based on the device key, the system decrypts the encrypted PIN to determine 910 the user PIN. According to at least one aspect of the method 900, the system 108, 110 can receive 902 the encrypted PIN, retrieve 908 the device key, and determine 910 the user PIN according to the method 700 described herein with respect to FIG. 7.

According to some aspects of the method 900, the system 108, 110 is the transaction service provider system 110. The transaction service provider system 110 can generate a re-encrypted PIN based on the user PIN and communicate the re-encrypted PIN to the issuer system 108 for decryption. The re-encryption of the PIN by the transaction service provider system 110 and the decryption of the re-encrypted PIN by the issuer system 108 can be performed according to existing PIN encryption and decryption methods employed across transaction service provider and issuer systems.

According to some aspects of the method 900, the system 108, 110 is the issuer system 108. The issuer system 108 can authenticate the transaction based on the user PIN and communicate a transaction authorization message to the access device 104.

According to some aspects of the method, the system 108, 110 provisions the device key to the user portable electronic device 106. The user portable electronic device 106 can generate the encrypted PIN that is included in the received 902 transaction authentication requested based on the user PIN and the provisioned device key.

According to some aspects of the method 900, the system 108, 110 determines 910 the user PIN by extracting a numeric diversifier from the encrypted PIN and generating a session key based on the device key and the numeric diversifier. The system 108, 110 decrypts the encrypted PIN based on the session key. In one aspect, the system 108, 110 extracts an indicator based on the encrypted PIN. The indicator can correspond to a transaction type of the transaction. The system 108, 110 further determines the transaction type of the transaction based on communicating with the access device 104. The system 108, 110 then compares the transaction type determined based on communicating with the access device 104 to the indicator extracted based on the encrypted PIN. In some aspects, the system 108, 110 can be configured to decline the transaction if the transaction type determined based on communicating with the access device 104 does not correspond to the indicator extracted based on the encrypted PIN.

According to one of the above aspects of the method 900, the system 108, 110 tracks a numeric diversifier count associated with the PAN and compares the numeric diversifier to the numeric diversifier count. The system 108, 110 can authenticate the transaction based on the numeric diversifier corresponding to the numeric diversifier count. The system 108, 110 can decline the transaction based on the numeric diversifier not corresponding to the numeric diversifier count.

According to some aspects of the method 900, the transaction is a first transaction and the transaction authentication request is a first transaction authentication request. The system 108, 110 can receive a second transaction authentication request comprising a personal account number (PAN) and the user PIN. For example, a user associated with the payment card 116 may have provided the user PIN instead of an encrypted PIN to the access device 104. The system 108, 110 can determine the PAN is associated with the dynamic encryption service, map the PAN to the token, and retrieve the device key based on the token. The system 108, 110 can attempt to decrypt the user PIN based on the device key and determine that the attempt to decrypt the user PIN based on the device key was unsuccessful. In one aspect, the system 108, 110 can decline the second transaction based on determining that the attempt to decrypt the user PIN based on the device key was unsuccessful. In another aspect, the system 108, 110 can verify the user PIN based on determining that the attempt to decrypt the user PIN based on the device key was unsuccessful and authenticate the second transaction.

FIG. 10 is a block diagram of a portable electronic device 2000, according to at least one aspect of the present disclosure. In some aspects, the portable electronic device 2000 can be the user portable electronic device 106 and/or the POS device 114 described above with respect to FIGS. 1-2. The portable electronic device 2000 includes processor 2002 that can communication via a data bus 2026 with various components such as a memory 2004, a display 2006, a network interface 2008, a speaker 2010, a microphone 2012, a camera 2014, a near field communication (NFC) antenna 2016, a Bluetooth antenna 2018, a WiFi antenna 2020, a biometric authentication module 2022, and/or external interface 2024.

The memory 2004 can store an application 2028 and may store other applications and/or programs such as an operating system. In aspects where the portable electronic device 2000 is the POS device 114 (FIG. 1) the application 2028 can include the point-of-sale application 122 described further herein. In aspects where the portable electronic device 2000 is the user portable electronic device 106 (FIG. 1), the application 2028 can include the PIN encryption application 120 described further herein.

The display 2006 may be or include a touch screen capable of presenting information to and receiving input from a user and/or a merchant. For example, the display 2006 can generate any of the interface screens described with respect to FIGS. 5A-5B.

The network interface 2008, the NFC antenna 2016, the Bluetooth antenna 2018, and the WiFi antenna 2020 may each support wireless communication. For example, the network interface 2008 can be configured to support cellular communication, the NFC antenna 2016 can be configured to support short-range radio communication, the Bluetooth antenna 2018 can be configured to support Bluetooth communication, and the WiFi can be configured to support WiFi communication. In some aspects, the NFC antenna 2016 can generate an electric field to power an integrated chip of a payment card. For example, in aspects where the portable electronic device 2000 is the POS device 114 (FIG. 1) the NFC antenna 2016 can be configured to communicate with an integrated chip of the payment card 116 to accept contactless payment from the payment card 116.

The biometric authentication module 2022 can be configured to analyze a physical feature of a user (e.g., as a fingerprint of the user, facial features of the user captured by the camera 2014, the user's voice captured by the speaker 2010) to confirm the user's identity. In aspects where the portable electronic device 2000 is the user portable electronic device 106 (FIG. 1), the PIN encryption application 120 (e.g., application 2028) can be configured approve a request to generate an encrypted PIN based on the biometric authentication module 2022 confirming the user's identity.

The external interface 2024 can be configured to connect the portable electronic device 2000 with various other hardware accessories. For example, in aspects where the portable electronic device 2000 is the POS device 114 (FIG. 1), hardware accessories such as an external payment card reader (e.g., a contactless payment card reader configured for NFC communication, a magnetic strip reader) may be connected to the portable electronic device 2000 via the external interface 2024.

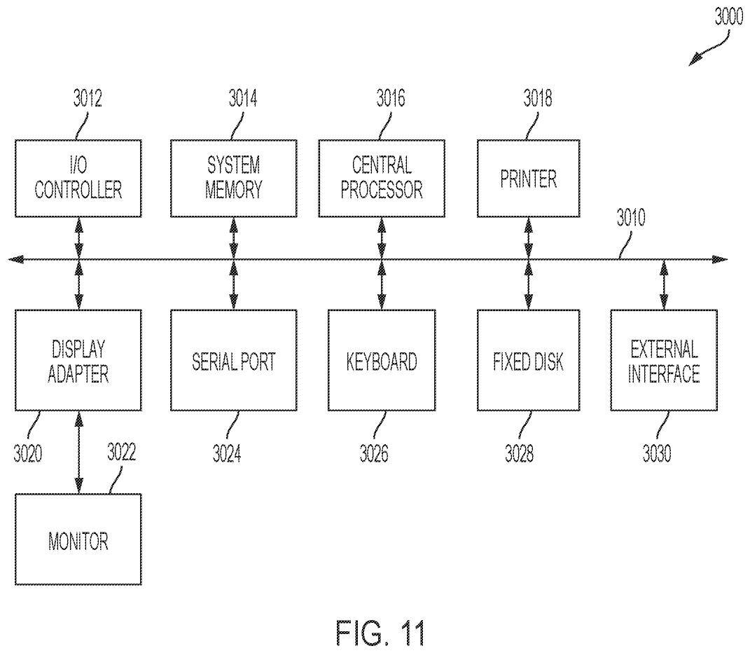

FIG. 11 is a block diagram of a computer apparatus 3000 comprising data processing subsystems or components, according to at least one aspect of the present disclosure. The subsystems shown in FIG. 11 are interconnected via a system bus 3010. Additional subsystems such as a printer 3018, keyboard 3026, fixed disk 3028 (or other memory comprising computer readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer readable medium.

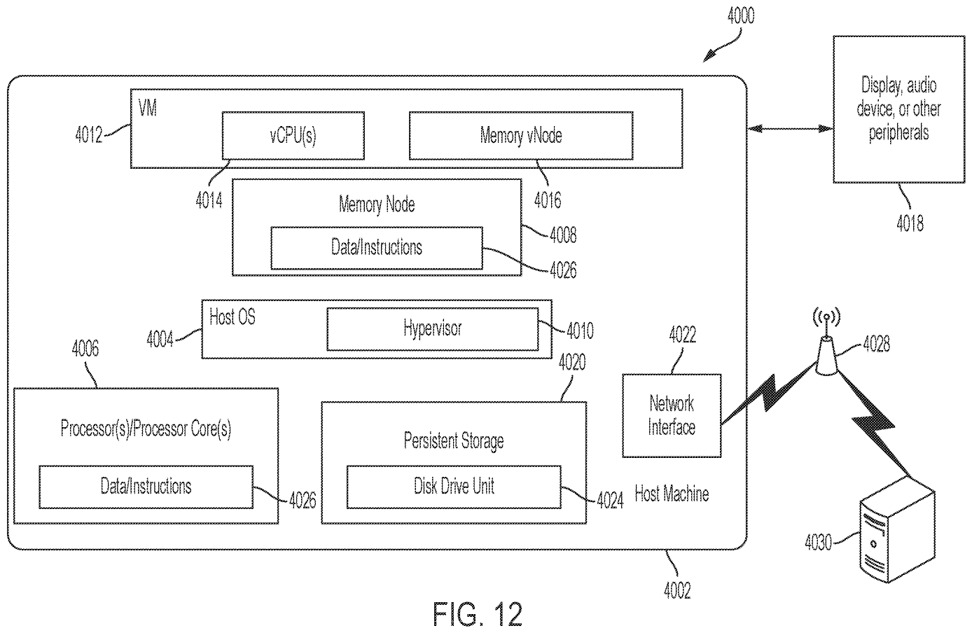

FIG. 12 is a diagrammatic representation of an example computing system 4000 that includes a host machine 4002 within which a set of instructions to perform any one or more of the methodologies discussed herein may be executed, such as, for example, the method 900 of FIG. 9, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment.

The host machine 4002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to the corresponding vNode 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4028 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

“Account credentials” may include any information that identifies an account and allows a payment processor to verify that a device, person, or entity has permission to access the account. For example, account credentials may include an account identifier (e.g., a primary account number (PAN)), a token (e.g., account identifier substitute), an expiration date, a cryptogram, a verification value (e.g., card verification value (CVV)), personal information associated with an account (e.g., address, etc.), an account alias, or any combination thereof. Account credentials may be static or dynamic such that they change over time.

A “payment application,” a “wallet application,” and/or a “PIN encryption application” may store credentials (e.g., account identifier, expiration date, card verification value (CVV), a PIN, etc.) for accounts provisioned onto a user device. The account credentials may be stored in general memory on the portable electronic device or on a secure trusted execution environment (e.g., a secure element) of the user device. Further, in some embodiments, the account credentials may be stored by a remote computer and the payment application, wallet application, and/or PIN encryption application may retrieve the credentials (or a portion thereof) from the remote computer before/during a transaction. Any number of different commands or communication protocols may be used to interface with the payment application, wallet application, and/or PIN encryption application in order to obtain and use stored credentials associated with each application.

“Provisioning” may include a process of providing data for use. For example, provisioning may include providing, delivering, or enabling a token on a device. Provisioning may be completed by any entity within or external to the transaction processing system. For example, in some embodiments, tokens may be provisioned by an issuer or a payment processing network onto a portable electronic device of a consumer (e.g., account holder). The provisioned tokens may have corresponding token data stored and maintained in the token vault or token registry. In some embodiments, a token vault or token registry may generate a token that may then be provisioned or delivered to a device. In some embodiments, an issuer may specify a token range from which token generation and provisioning can occur. Further, in some embodiments, an issuer may generate and notify a token vault of a token value and provide the token record information (e.g., token attributes) for storage in the token vault.

Examples of the devices, systems, and methods according to various aspects of the present disclosure are provided below in the following numbered clauses. An aspect of any of the devices(s), method(s) and/or system(s) may include any one or more than one, and any combination of, the numbered clauses described below.

Clause 1: A method for securely providing a user personal identification number (PIN), the method comprising: receiving, by a portable electronic device, a device key provisioned by a server, wherein the device key is associated with a payment card; receiving, by the portable electronic device, a request for an encrypted PIN to authenticate a transaction initiated using the payment card; generating, by a PIN encryption application executed by the portable electronic device, the encrypted PIN based on the user PIN and the device key; and providing, by the portable electronic device, the encrypted PIN to an access device, wherein the access device is configured to communicate the encrypted PIN to the server.

Clause 2: The method of Clause 1, wherein generating the encrypted PIN based on the user PIN and the device key comprises: retrieving, by the PIN encryption application, a first numeric diversifier from a set of numeric diversifiers; generating, by the PIN encryption application, a first session key based on the device key and the first numeric diversifier; and generating, by the PIN encryption application, the encrypted PIN based on the first session key; wherein the server is configured extract the first numeric diversifier from the encrypted PIN, generate the first session key based on the device key and the first numeric diversifier, and decrypt the encrypted PIN based on the first session key.

Clause 3: The method of Clause 2, wherein the transaction is a first transaction and the encrypted PIN is a first encrypted PIN, the method further comprising: storing, by the portable electronic device, the set of numeric diversifiers; retrieving, by the PIN encryption application, a second numeric diversifier from the set of numeric diversifiers; generating, by the PIN encryption application, a second session key based on the device key and the second numeric diversifier; and generating, by the PIN encryption application, a second encrypted PIN based on the second session key, wherein the second encrypted PIN is for authenticating a second transaction.

Clause 4: The method of any of Clauses 2-3, further comprising: receiving, by the portable electronic device, a new device key provisioned by the server based on a count corresponding to the set of numeric diversifiers reaching a predetermined threshold.

Clause 5: The method of any of Clauses 2-4, wherein the encrypted PIN is generated based on the user PIN and the device key without the portable electronic device being connected to a network.

Clause 6: The method of Clauses 2-5, wherein the device key comprises a 16 byte alphanumeric string, and wherein generating the encrypted PIN based on the user PIN and the device key further comprises: padding, by the PIN encryption application, the first numeric diversifier to generate a padded diversifier, wherein the padded diversifier comprises an 8 byte alphanumeric string; deriving, by the PIN encryption application, the first session key based on the device key and the padded diversifier; generating, by the PIN encryption application, a numeric session key based on the first session key; generating, by the PIN encryption application, a truncated numeric session key having a string length equal to a string length of the user PIN by truncating the numeric session key; and generating, by the PIN encryption application, the encrypted PIN by sequentially adding each digit of the truncated numeric session key to a corresponding digit of the user PIN.

Clause 7: The method of any of Clauses 1-6, further comprising: receiving, by the PIN encryption application, a user input designating a transaction type of the transaction; and generating, by the PIN encryption application, the encrypted PIN based on an indicator corresponding to the transaction type; wherein the server is configured to extract the indicator from the encrypted PIN and compare the indicator to a transaction type identified based on communicating with the access device.

Clause 8: The method of any of Clauses 1-7, wherein receiving the request for the encrypted PIN comprises at least one of: receiving, by the portable electronic device, the user PIN; receiving, by the portable electronic device, a passcode; or receiving, by the portable electronic device, a user biometric authentication; or a combination thereof.

Clause 9: The method of any of Clauses 1-8, further comprising: transmitting, by the portable electronic device, a geolocation of the portable electronic device to the server; wherein the server is configured to compare the geolocation of the portable electronic device to a geolocation of the access device.

Clause 10: The method of any of Clauses 1-9, wherein the access device comprises a merchant portable electronic device executing a point-of-sale application.

Clause 11: A method for authenticating a transaction, wherein the transaction is initiated using a payment card and an access device, wherein the transaction requires authentication based on a user personal identification number (PIN), and wherein an encrypted PIN generated based on the user PIN is provided to the access device to authenticate the transaction, the method comprising: receiving, by a server, a transaction authentication request comprising the encrypted PIN from the access device, wherein the transaction authentication request is associated with a personal account number (PAN); determining, by the server, the PAN is associated with a PIN encryption service; mapping, by the server, the PAN to a token; retrieving, by the server, a device key based on the token; and determining, by the server, the user PIN by decrypting the encrypted PIN based on the device key.

Clause 12: The method of Clause 11, wherein the server is a transaction service provider server, the method further comprising: generating, by the transaction service provider server, a re-encrypted PIN based on the user PIN; and communicating, by the transaction service provider server, the re-encrypted PIN to an issuer server for decryption.

Clause 13: The method of Clause 11, wherein the server is an issuer server, the method further comprising: authenticating, by the issuer server, the transaction based on the user PIN; and communicating, by the issuer server, a transaction authorization message to the access device.

Clause 14: The method of any of Clauses 11-13, further comprising: provisioning, by the server, the device key to a user portable electronic device, wherein the user portable electronic device generates the encrypted PIN based on the user PIN and the device key.

Clause 15: The method of any of Clauses 11-14, wherein determining the user PIN by decrypting the encrypted PIN based on the device key comprises: extracting, by the server, a numeric diversifier from the encrypted PIN; generating, by the server, a session key based on the device key and the numeric diversifier; and decrypting, by the server, the encrypted PIN based on the session key.

Clause 16: The method of Clause 15, wherein determining the user PIN by decrypting the encrypted PIN based on the device key further comprises: extracting, by the server, an indicator based on the encrypted PIN, wherein the indicator corresponds to a transaction type of the transaction; determining, by the server, the transaction type of the transaction based on communicating with the access device; and comparing, by the server, the transaction type determined based on communicating with the access device to the indicator extracted based on the encrypted PIN.

Clause 17: The method of any of Clauses 15-16, further comprising: tracking, by the server, a numeric diversifier count associated with the PAN; comparing, by the server, the numeric diversifier to the numeric diversifier count; and authenticating, by the server, the transaction based on the numeric diversifier corresponding to the numeric diversifier count.

Clause 18: The method of Clauses 11-17, wherein the transaction is a first transaction and the transaction authentication request is a first transaction authentication request, the method further comprising: receiving, by the server, a second transaction authentication request corresponding to a second transaction, the second transaction authentication request comprising the PAN and the user PIN; determining, by the server, the PAN is associated with the encryption service; mapping, by the server, the PAN to the token; retrieving, by the server, the device key based on the token; attempting, by the server, to decrypt the user PIN based on the device key; and determining, by the server, that the attempt to decrypt the user PIN based on the device key was unsuccessful.

Clause 19: The method of Clause 18, further comprising: declining, by the server, the second transaction based on determining that the attempt to decrypt the user PIN based on the device key was unsuccessful; or verifying, by the server, the user PIN and authenticating the second transaction.

Clause 20: A portable electronic device, comprising: a display screen; a processor; and a memory, wherein the memory comprises instructions executable by the processor to: receive a request to enroll a payment card to a personal identification number (PIN) encryption service; receive a device key provisioned by a server, wherein the device key is associated with the payment card; cause the display screen to display a first user interface for receiving a user PIN; generate an encrypted PIN based on the user PIN and the device key, wherein the encrypted PIN is for authenticating a transaction initiated using the payment card and an access device; and cause the display screen to display a second user interface comprising the encrypted PIN, wherein the access device is configured receive the encrypted PIN and communicate the encrypted PIN to the server.

Further, it is understood that any one or more of the following-described forms, expressions of forms, examples, can be combined with any one or more of the other following-described forms, expressions of forms, and examples.

While several forms have been illustrated and described, it is not the intention of Applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

As used herein, a “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, a “server computer” may describe a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

Reference to “a device,” “a server,” “a processor,” and/or the like, as used herein, may refer to a previously recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

The term “substantially”, “about”, or “approximately” as used in the present disclosure, unless otherwise specified, means an acceptable error for a particular value as determined by one of ordinary skill in the art, which depends in part on how the value is measured or determined. In certain aspects, the term “substantially”, “about”, or “approximately” means within 1, 2, 3, or 4 standard deviations. In certain aspects, the term “substantially”, “about”, or “approximately” means within 50%, 20%, 15%, 10%, 9%, 8%, 7%, 6%, 5%, 4%, 3%, 2%, 1%, 0.5%, or 0.05% of a given value or range.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

1. A method for securely providing a user personal identification number (PIN), the method comprising:
receiving, by a portable electronic device, a device key provisioned by a server, wherein the device key is associated with a payment card;
receiving, by the portable electronic device, a request for an encrypted PIN to authenticate a transaction initiated using the payment card;
generating, by a PIN encryption application executed by the portable electronic device, the encrypted PIN based on the user PIN and the device key; and
providing, by the portable electronic device, the encrypted PIN to an access device, wherein the access device is configured to communicate the encrypted PIN to the server.

2. The method of claim 1, wherein generating the encrypted PIN based on the user PIN and the device key comprises:
retrieving, by the PIN encryption application, a first numeric diversifier from a set of numeric diversifiers;
generating, by the PIN encryption application, a first session key based on the device key and the first numeric diversifier; and
generating, by the PIN encryption application, the encrypted PIN based on the first session key;
wherein the server is configured extract the first numeric diversifier from the encrypted PIN, generate the first session key based on the device key and the first numeric diversifier, and decrypt the encrypted PIN based on the first session key.

3. The method of claim 2, wherein the transaction is a first transaction and the encrypted PIN is a first encrypted PIN, the method further comprising:
storing, by the portable electronic device, the set of numeric diversifiers;
retrieving, by the PIN encryption application, a second numeric diversifier from the set of numeric diversifiers;
generating, by the PIN encryption application, a second session key based on the device key and the second numeric diversifier; and
generating, by the PIN encryption application, a second encrypted PIN based on the second session key, wherein the second encrypted PIN is for authenticating a second transaction.

4. The method of claim 3, further comprising:
receiving, by the portable electronic device, a new device key provisioned by the server based on a count corresponding to the set of numeric diversifiers reaching a predetermined threshold.

5. The method of claim 2, wherein the encrypted PIN is generated based on the user PIN and the device key without the portable electronic device being connected to a network.

6. The method of claim 2, wherein the device key comprises a 16 byte alphanumeric string, and wherein generating the encrypted PIN based on the user PIN and the device key further comprises:
padding, by the PIN encryption application, the first numeric diversifier to generate a padded diversifier, wherein the padded diversifier comprises an 8 byte alphanumeric string;
deriving, by the PIN encryption application, the first session key based on the device key and the padded diversifier;
generating, by the PIN encryption application, a numeric session key based on the first session key;
generating, by the PIN encryption application, a truncated numeric session key having a string length equal to a string length of the user PIN by truncating the numeric session key; and
generating, by the PIN encryption application, the encrypted PIN by sequentially adding each digit of the truncated numeric session key to a corresponding digit of the user PIN.

7. The method of claim 1, further comprising:
receiving, by the PIN encryption application, a user input designating a transaction type of the transaction; and
generating, by the PIN encryption application, the encrypted PIN based on an indicator corresponding to the transaction type;
wherein the server is configured to extract the indicator from the encrypted PIN and compare the indicator to a transaction type identified based on communicating with the access device.

8. The method of claim 1, wherein receiving the request for the encrypted PIN comprises at least one of:
receiving, by the portable electronic device, the user PIN;
receiving, by the portable electronic device, a passcode; or
receiving, by the portable electronic device, a user biometric authentication; or
a combination thereof.

9. The method of claim 1, further comprising:
transmitting, by the portable electronic device, a geolocation of the portable electronic device to the server;
wherein the server is configured to compare the geolocation of the portable electronic device to a geolocation of the access device.

10. The method of claim 1, wherein the access device comprises a merchant portable electronic device executing a point-of-sale application.

11. A method for authenticating a transaction, wherein the transaction is initiated using a payment card and an access device, wherein the transaction requires authentication based on a user personal identification number (PIN), and wherein an encrypted PIN generated based on the user PIN is provided to the access device to authenticate the transaction, the method comprising:
receiving, by a server, a transaction authentication request comprising the encrypted PIN from the access device, wherein the transaction authentication request is associated with a personal account number (PAN);
determining, by the server, the PAN is associated with a PIN encryption service;
mapping, by the server, the PAN to a token;
retrieving, by the server, a device key based on the token; and
determining, by the server, the user PIN by decrypting the encrypted PIN based on the device key.

12. The method of claim 11, wherein the server is a transaction service provider server, the method further comprising:
generating, by the transaction service provider server, a re-encrypted PIN based on the user PIN; and
communicating, by the transaction service provider server, the re-encrypted PIN to an issuer server for decryption.

13. The method of claim 11, wherein the server is an issuer server, the method further comprising:
authenticating, by the issuer server, the transaction based on the user PIN; and
communicating, by the issuer server, a transaction authorization message to the access device.

14. The method of claim 11, further comprising:
provisioning, by the server, the device key to a user portable electronic device, wherein the user portable electronic device generates the encrypted PIN based on the user PIN and the device key.

15. The method of claim 11, wherein determining the user PIN by decrypting the encrypted PIN based on the device key comprises:
extracting, by the server, a numeric diversifier from the encrypted PIN;
generating, by the server, a session key based on the device key and the numeric diversifier; and
decrypting, by the server, the encrypted PIN based on the session key.

16. The method of claim 15, wherein determining the user PIN by decrypting the encrypted PIN based on the device key further comprises:
extracting, by the server, an indicator based on the encrypted PIN, wherein the indicator corresponds to a transaction type of the transaction;
determining, by the server, the transaction type of the transaction based on communicating with the access device; and
comparing, by the server, the transaction type determined based on communicating with the access device to the indicator extracted based on the encrypted PIN.

17. The method of claim 15, further comprising:
tracking, by the server, a numeric diversifier count associated with the PAN;
comparing, by the server, the numeric diversifier to the numeric diversifier count; and
authenticating, by the server, the transaction based on the numeric diversifier corresponding to the numeric diversifier count.

18. The method of claim 11, wherein the transaction is a first transaction and the transaction authentication request is a first transaction authentication request, the method further comprising:
receiving, by the server, a second transaction authentication request corresponding to a second transaction, the second transaction authentication request comprising the PAN and the user PIN;
determining, by the server, the PAN is associated with the encryption service;
mapping, by the server, the PAN to the token;
retrieving, by the server, the device key based on the token;
attempting, by the server, to decrypt the user PIN based on the device key; and
determining, by the server, that the attempt to decrypt the user PIN based on the device key was unsuccessful.

19. The method of claim 18, further comprising:
declining, by the server, the second transaction based on determining that the attempt to decrypt the user PIN based on the device key was unsuccessful; or
verifying, by the server, the user PIN and authenticating the second transaction.

20. A portable electronic device, comprising:
a display screen;
a processor; and
a memory, wherein the memory comprises instructions executable by the processor to:
receive a request to enroll a payment card to a personal identification number (PIN) encryption service;
receive a device key provisioned by a server, wherein the device key is associated with the payment card;
cause the display screen to display a first user interface for receiving a user PIN;
generate an encrypted PIN based on the user PIN and the device key, wherein the encrypted PIN is for authenticating a transaction initiated using the payment card and an access device; and
cause the display screen to display a second user interface comprising the encrypted PIN, wherein the access device is configured receive the encrypted PIN and communicate the encrypted PIN to the server.
